(19) United States
(12) Patent Application Publication
(10) Pub. No.: US 2015/0153965 A1
(43) Pub. Date: Jun. 4, 2015

(54) ELECTRONIC SYSTEM AND METHOD OF OPERATING THE SAME

(71) Applicant: SAMSUNG ELECTRONICS CO., LTD., Suwon-si (KR)

(72) Inventor: CHAN IK PARK, Suwon-si (KR)

(21) Appl. No.: 14/476,964

(22) Filed: Sep. 4, 2014

(30) Foreign Application Priority Data
Nov. 29, 2013 (KR) 10-2013-0147508

(51) Int. Cl. G06F 3/06; G06F 11/10

(52) U.S. Cl. CPC G06F 3/0658; G06F 3/0604; G06F 3/0683; G06F 11/10

(57) ABSTRACT

An electronic system includes a host, a volatile memory, a non-volatile memory, and a controller configured to manage the volatile memory and the non-volatile memory according to control of the host. The controller assigns a portion of the non-volatile memory as a virtual volatile memory region. Data that is requested by the host to be stored in the volatile memory that cannot fit entirely within the volatile memory may be stored by the controller in the portion of the non-volatile memory assigned as the virtual volatile memory region.

### CROSS-REFERENCE TO RELATED APPLICATIONS

This application claims priority under 35 U.S.C. §119(a) to Korean Patent Application No. 10-2013-0147508 filed on Nov. 29, 2013, the disclosure of which is incorporated by reference in its entirety herein.

### BACKGROUND

1. Technical Field

Exemplary embodiments of the inventive concept relate to an electronic system and a method of operating the same.

2. Discussion of Related Art

A memory system used for smart phones or the like includes volatile memory (e.g., dynamic random access memory (DRAM)) operating as working memory and non-volatile memory for storage. With the decrease in size of DRAM, the probability of error increases. Therefore, an error correction code (ECC) is also stored in DRAM during data writing and the ECC is read when data is read and used to correct errors. However, when the ECC is used, an additional storage space is required in DRAM, and therefore, the data storage capacity of DRAM is decreased.

Further, when each of the volatile memory and the non-volatile memory stores a separate mapping table therein, there is redundant use of memory resources.

### SUMMARY

According to an exemplary embodiment of the inventive concept, there is provided an electronic system which can control different memories using a UMC controller. The electronic system includes a host, a volatile memory, a non-volatile memory, and the UMC controller. The UMC controller is configured to manage the volatile memory and the non-volatile memory according to control of the host. The UMC controller assigns a portion of the non-volatile memory as a virtual volatile memory region.

The volatile memory may include a mapping table that maps a logical address of the host to a physical address of the volatile memory and a second physical address of the non-volatile memory.

The mapping table may include a valid bit corresponding to each entry. The UMC controller may receive the mapping table from the volatile memory, access the volatile memory when the valid bit corresponding to the logical address of the host is at a first level, and access the non-volatile memory when the valid bit corresponding to the logical address of the host is at a second level.

The first physical address may be different from the second physical address.

The volatile memory may store volatile data and an error correction code (ECC) corresponding to the volatile data.

The UMC controller may assign a space corresponding to the ECC in the non-volatile memory as the virtual volatile memory region.

The UMC controller may receive at least one first signal corresponding to an interface of the volatile memory from the host and access the volatile memory or the non-volatile memory according to the first signal.

The UMC controller may include a non-volatile memory interface configured to convert the first signal into at least one second signal corresponding to an interface of the non-volatile memory.

The UMC controller may output the first signal to the volatile memory or may output the second signal to the non-volatile memory.

The host and the UMC controller may be integrated into a single system-on-chip.

According to an exemplary embodiment of the inventive concept, there is provided a method of operating an electronic system. The method includes receiving a memory access request that includes a virtual address, receiving a mapping table from a main memory, determining whether to access the main memory or an auxiliary memory according to the mapping table and the virtual address, translating the virtual address into a physical address according to the mapping table, and accessing one of the main memory and the auxiliary memory according to a result of the determination and the physical address.

The method may further include receiving at least one first signal corresponding to interface of the main memory from a host.

The accessing the main memory or the auxiliary memory may include outputting the first signal to the main memory according to the result of the determination to access the main memory.

The accessing the main memory or the auxiliary memory may include converting the first signal into at least one second signal corresponding to an interface of the auxiliary memory according to the result of the determination to access the auxiliary memory and outputting the second signal to the auxiliary memory.

The method may further include storing data and an ECC corresponding to the data in the main memory and assigning a space corresponding to the ECC in the non-volatile memory as a virtual volatile memory region.

According to an exemplary embodiment of the inventive concept, there is provided an electronic system. The electronic system includes a volatile memory, a non-volatile memory, and a controller. The controller is configured to interface with both the volatile memory and the non-volatile memory. The controller is configured to receive a request to store data into the volatile memory. The controller stores a part of the data that exceeds a capacity of the volatile memory into the non-volatile memory.

The electronic system may include a memory controller configured to generate a first signal configured to interface with the volatile memory, where the controller sends the first signal received from the memory controller to the volatile memory to store the data not exceeding the capacity in the volatile memory.

The controller may convert the first signal into a second signal configured to interface with the non-volatile memory, and send the second signal to the non-volatile memory to store the data exceeding the capacity in the non-volatile memory.

The non-volatile memory may include a first region for storing the part of the data, and a second other region for storing data that is requested to be stored into the non-volatile memory.

The controller may access a mapping table of the volatile memory to determine whether data of the non-volatile memory requested by a host is located in one of the volatile memory and the non-volatile memory.

### BRIEF DESCRIPTION OF THE DRAWINGS

The inventive concept will become more apparent by describing in detail exemplary embodiments thereof with reference to the attached drawings in which:

FIG. 1 is a block diagram of an electronic system according to an exemplary embodiment of the inventive concept;

FIG. 2 is a block diagram of an electronic system according to an exemplary embodiment of the inventive concept;

FIG. 3 is a detailed block diagram of a part of the electronic system illustrated in FIG. 1 according to an exemplary embodiment of the inventive concept;

FIG. 4 is a diagram of a software stack in a central processing unit (CPU) illustrated in FIG. 1 according to an exemplary embodiment of the inventive concept;

FIG. 5 is a diagram of a mapping table illustrated in FIG. 3 according to an exemplary embodiment of the inventive concept;

FIG. 6 is a flowchart of a method of operating the electronic system illustrated in FIG. 1 according to an exemplary embodiment of the inventive concept; and

FIG. 7 is a flowchart of a method of operating the electronic system illustrated in FIG. 1 according to an exemplary embodiment of the inventive concept.

### DETAILED DESCRIPTION

The inventive concept now will be described more fully hereinafter with reference to the accompanying drawings, in which embodiments of the invention are shown. This invention may, however, be embodied in many different forms and should not be construed as limited to the exemplary embodiments set forth herein. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. As used herein, the singular forms “a”, “an” and “the” are intended to include the plural forms as well, unless the context clearly indicates otherwise.

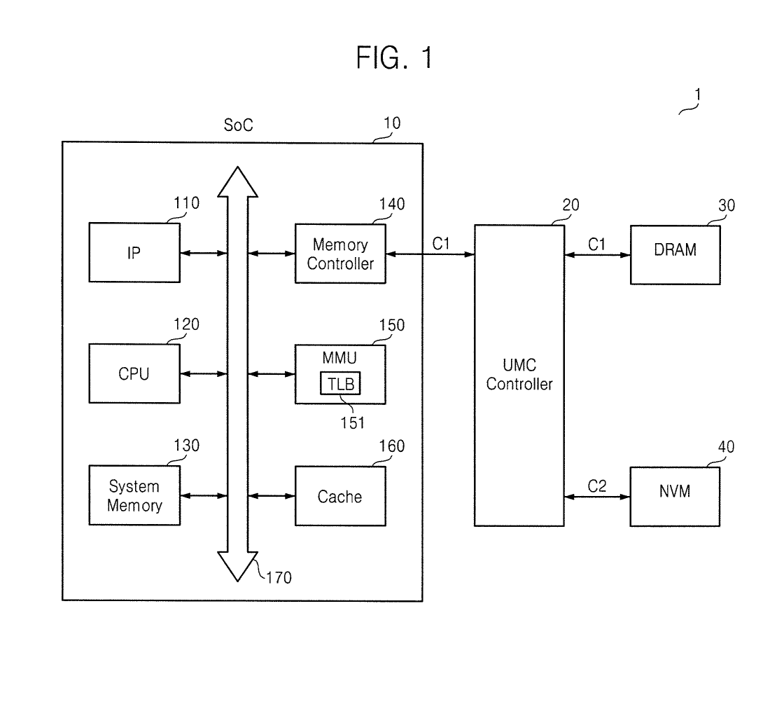

FIG. 1 is a block diagram of an electronic system 1 according to an exemplary embodiment of the inventive concept. The electronic system 1 may be implemented as a handheld device such as a mobile phone, a smart phone, a tablet computer, a personal digital assistant (PDA), an enterprise digital assistant (EDA), a digital still camera, a digital video camera, a portable multimedia player (PMP), a personal navigation device or portable navigation device (PND), a handheld game console, or an e-book reader. In an exemplary embodiment of the inventive concept, the electronic system 1 includes a system-on-chip (SoC) 10, a UMC controller 20, a main memory 30, and a storage device 40. In an exemplary embodiment, the UMC stands for universal memory chip or universal memory controller, and the UMC controller is capable of interfacing with at least two different types of memories (e.g., volatile and non-volatile).

The SoC 10 is an integrated circuit (IC) in which blocks having various functions are integrated to implement an electronic system. The SoC 10 may include at least one intellectual property (IP) 110, a central processing unit (CPU) 120, a system memory 130, a memory controller 140, a memory management unit (MMU) 150, and a cache memory 160. The SoC 10 may also include other elements such as a TV processor and a power management IC (PMIC) apart from the elements illustrated in FIG. 1.

The IP 110 is a circuit, logic, or a combination thereof, which can be integrated into the SoC 10. Codes may be stored in the circuit or the logic. In an exemplary embodiment, the codes include executable program codes, data, addresses, etc. The IP 110 may be controlled by the CPU 120. The IP 110 may be a graphics processing unit (GPU), a multi-format codec (MFC), a video module (e.g., a camera interface, a Joint Photographic Experts Group (JPEG) processor, a video processor, or a mixer), an audio system, a driver, a display driver, a serial port, a system timer, a watch dog timer, or an analog-to-digital converter.

In an exemplary embodiment, the MFC supports high resolution decoding and encoding functionalities. While a JPEG processor is described above, the inventive concept is not limited to any particular image format. In an exemplary embodiment, the mixer is an electronic mixer that combines two or more electrical signals into one or two composite signals. The watch dog timer may also be referred to as computer operating properly (COP) timer, which is an electronic timer that may be used to detect and recover from computer malfunctions. In an exemplary embodiment, the driver is a device driver, which is a computer program that operates or controls a particular type of physical device.

The CPU 120, which may be referred to as a processor, may process or execute programs and/or data stored in the main memory 30. For instance, the CPU 120 may process or execute the programs and/or the data in response to a clock signal output from a clock signal generator (not shown).

The CPU 120 may be implemented as a multi-core processor. The multi-core processor is a single computing component with two or more independent actual processors (referred to as cores). Each of the processors may read and execute program instructions. The multi-core processor can drive a plurality of accelerators at a time, and therefore, a data processing system including the multi-core processor may perform multi-acceleration.

The programs and/or the data stored in the system memory 130, the cache memory 160, the main memory 30, and the storage device 40 may be loaded to a memory in the CPU 120 when necessary.

The system memory 130 is a storage medium for storing data and may store an operating system (OS) and various kinds of programs and data. The system memory 130 may be implemented as read-only memory (ROM) that permanently stores programs and/or data or random access memory (RAM) that temporarily stores programs, data, or instructions. The ROM may be implemented as an erasable programmable ROM (EPROM) or an electrically erasable programmable ROM (EEPROM). The RAM may be implemented as dynamic RAM (DRAM) or static RAM (SRAM).

The memory controller 140 is a block for interfacing with the UMC controller 20. The memory controller 140 controls the overall operation of the UMC controller 20 and also controls the overall data exchange between a host and the UMC controller 20. For instance, the memory controller 140 may control the UMC controller 20 to write data to or read data from the main memory 30 or the storage device 40 at the request of the host. The host may be a master device such as the IP 110 or the CPU 120.

The MMU 150 may be a computer hardware component that manages the access of the CPU 120 to the main memory 30 and the storage device 40. The MMU 150 may perform memory address translation, memory protection, cache management, and bus arbitration. According to an exemplary embodiment of the inventive concept, the MMU 150 is in charge of bank switching. In an exemplary embodiment, bank switching is a technique to increase the amount of usable memory beyond the amount directly addressable by the processor. The MMU 150 may include a translation lookaside buffer (TLB) 151 for dynamic address translation. In an exemplary embodiment, the TLB 151 is used to improve virtual address translation speed.

The cache memory 160 may be used to reduce performance deterioration caused by long access latency of the main memory 30. The cache memory 160 may be implemented as volatile memory, e.g., an SRAM.

The main memory 30 and the storage device 40 may store instructions and data that are executed by the CPU 120. According to an exemplary embodiment of the inventive concept, the main memory 30 is implemented as a volatile memory and the storage device 40 is implemented as a non-volatile memory.

For instance, the main memory 30 may be implemented as DRAM, SRAM, thyristor RAM (T-RAM), zero-capacitor RAM (Z-RAM), or twin transistor RAM (TTRAM). The storage device 40 may be implemented as EEPROM, flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, molecular electronic memory device, or insulator resistance change memory.

The elements 110, 120, 130, 140, 150, and 160 communicate with one another through a system bus 170.

The UMC controller 20 may universally manage the volatile memory 30 and the non-volatile memory (NVM) 40 according to the control of the MMU 150. The UMC controller 20 may receive at least one first signal C1 corresponding to an interface (e.g., a double data rate (DDR) interface) of the volatile memory 30 from the memory controller 140. For example, the first signal C1 may be formatted to be compatible with interfacing with the volatile memory 30. According to an exemplary embodiment of the inventive concept, the first signal C1 includes a row address strobe (RAS) signal and a column address strobe (CAS) signal.

The UMC controller 20 may access the volatile memory 30 or the non-volatile memory 40 according to the first signal C1. For instance, the UMC controller 20 may output the first signal C1 to the volatile memory 30 or may convert the first signal C1 into at least one second signal C2 corresponding to an interface of the NVM 40 (e.g., a flash memory) and output the second signal C2 to the NVM 40. For example, the second signal C2 may be formatted to be compatible with interfacing with the NVM 40.

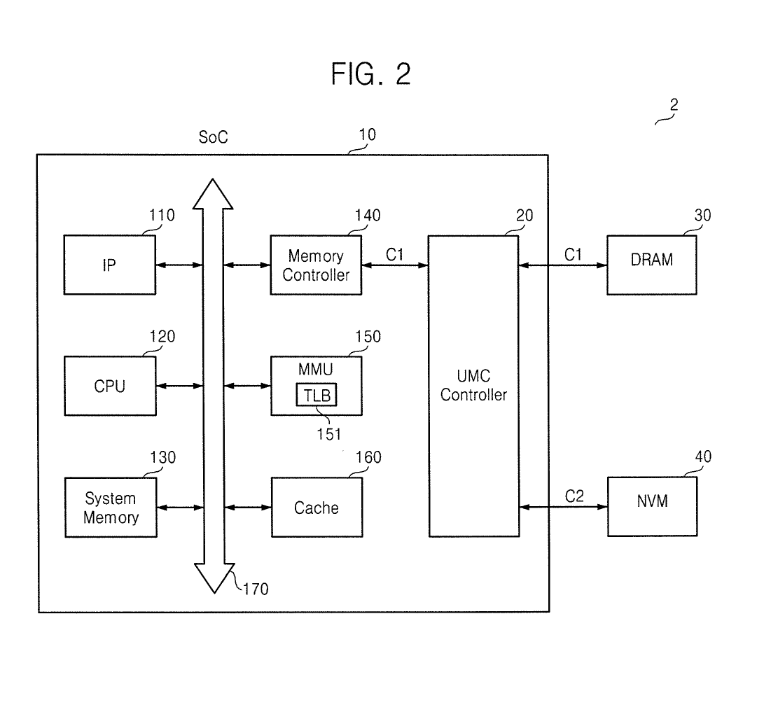

FIG. 2 is a block diagram of an electronic system 2 according to an exemplary embodiment of the inventive concept. The electronic system 2 illustrated in FIG. 2 is nearly the same as the electronic system 1 illustrated in FIG. 1. For example, unlike the embodiment shown in FIG. 1 where the UMC controller 20 is located outside the SoC 10, in the embodiment shown in FIG. 2 the UMC controller 20 is located inside the SoC 10. Further, unlike the embodiment shown in FIG. 1 where the SoC 10 is capable of communicating with the at least one first signal C1, in the embodiment shown in FIG. 2 the SoC is capable of communicating using both the at least one first signal C1 and the at least one second signal C2.

Referring to FIG. 2, the electronic system 2 may be implemented as a handheld device such as a mobile phone, a smart phone, a tablet computer, a PDA, an EDA, a digital still camera, a digital video camera, a PMP, a PND, a handheld game console, or an e-book. The electronic system 2 may include the SoC 10, the main memory 30, and the storage device 40.

The SoC 10 is an IC in which blocks having various functions are integrated to implement an electronic system. The SoC 10 may include the at least one IP 110, the CPU 120, the system memory 130, the memory controller 140, the MMU 150, the cache memory 160, and the UMC controller 20. The SoC 10 may also include other elements such as a TV processor and a PMIC apart from the elements illustrated in FIG. 2.

The IP 110 is a circuit, a logic, or a combination thereof, which can be integrated into the SoC 10. Codes may be stored in the circuit or the logic. The IP 110 may be controlled by the CPU 120. The IP 110 may be a GPU, an MFC, a video module (e.g., a camera interface, a JPEG processor, a video processor, or a mixer), an audio system, a driver, a display driver, a serial port, a system timer, a watch dog timer, or an analog-to-digital converter.

The CPU 120, which may be referred to as a processor, may process or execute programs and/or data stored in the main memory 30. For instance, the CPU 120 may process or execute the programs and/or the data in response to a clock signal output from a clock signal generator (not shown).

The CPU 120 may be implemented as a multi-core processor. The multi-core processor is a single computing component with two or more independent actual processors (referred to as cores). Each of the processors may read and execute program instructions. The multi-core processor can drive a plurality of accelerators at a time, and therefore, a data processing system including the multi-core processor may perform multi-acceleration.

The programs and/or the data stored in the system memory 130, the cache memory 160, the main memory 30, and the storage device 40 may be loaded to a memory in the CPU 120 when necessary.

The system memory 130 is a storage medium for storing data and may store an OS and various kinds of programs and data. The system memory 130 may be implemented as ROM that permanently stores programs and/or data or RAM that temporarily stores programs, data, or instructions. The ROM may be implemented as an EPROM or an EEPROM. The RAM may be implemented as DRAM or SRAM.

The memory controller 140 is a block for interfacing with the UMC controller 20. The memory controller 140 controls the overall operation of the UMC controller 20 and also controls the overall data exchange between a host and the UMC controller 20. For instance, the memory controller 140 may control the UMC controller 20 to write data to or read data from the main memory 30 or the storage device 40 at the request of the host. The host may be a master device such as the IP 110 or the CPU 120.

The MMU 150 may be a computer hardware component that manages the access of the CPU 120 to the main memory 30 and the storage device 40. The MMU 150 may perform memory address translation, memory protection, cache management, and bus arbitration. According to an exemplary embodiment of the inventive concept, the MMU 150 is in charge of bank switching. The MMU 150 may include the TLB 151 for dynamic address translation.

The cache memory 160 may be used to reduce performance deterioration caused by long access latency of the main memory 30. The cache memory 160 may be implemented as volatile memory, e.g., an SRAM.

The main memory 30 and the storage device 40 may store instructions and data that are executed by the CPU 120. According to an exemplary embodiment of the inventive concept, the main memory 30 is implemented as a volatile memory and the storage device 40 is implemented as a non-volatile memory.

For instance, the main memory 30 may be implemented as DRAM, SRAM, T-RAM, Z-RAM, or TTRAM. Hereinafter, it is assumed that the main memory 30 is implemented as DRAM.

The storage device 40 may be implemented as EEPROM, flash memory, MRAM, STT-MRAM, CBRAM, FeRAM, PRAM, RRAM, nanotube RRAM, PoRAM, NFGM, holographic memory, molecular electronic memory device, or insulator resistance change memory.

The elements 110, 120, 130, 140, 150, and 160 communicate with one another through a system bus 170.

The UMC controller 20 may universally manage the volatile memory 30 and the NVM 40 according to the control of the MMU 150. The UMC controller 20 may receive at least one first signal C1 corresponding to an interface (e.g., a DDR interface) of the volatile memory 30 from the memory controller 140. According to an exemplary embodiment, the first signal C1 includes a RAS signal and a CAS signal.

The UMC controller 20 may access the volatile memory 30 or the non-volatile memory 40 according to the first signal C1. For instance, the UMC controller 20 may output the first signal C1 to the volatile memory 30 or may convert the first signal C1 into at least one second signal C2 corresponding to an interface of the NVM 40 (e.g., flash memory) and output the second signal C2 to the NVM 40.

According to an exemplary embodiment of the inventive concept, a memory controller for a volatile memory and a storage controller for a NVM are integrated into one device, so that cost is reduced as compared to a case where the storage controller is separately used. In addition, the volatile memory can also use an error correction code (ECC) and memory space used by the ECC in the volatile memory can be compensated using the NVM.

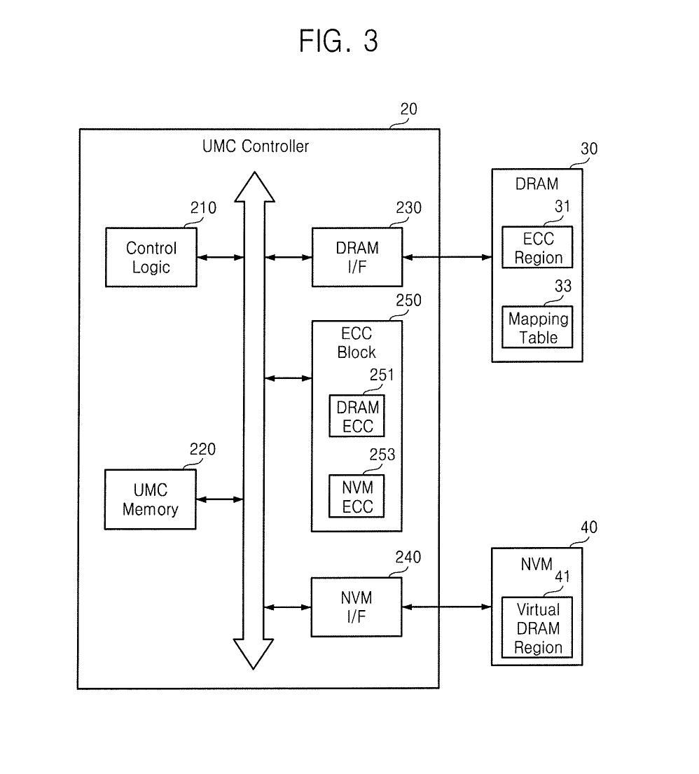

FIG. 3 is a detailed block diagram of a part of the electronic system 1 illustrated in FIG. 1 according to an exemplary embodiment of the inventive concept. Referring to FIGS. 1 and 3, the UMC controller 20 includes a control logic 210, a UMC memory 220, a DRAM interface (I/F) 230, an NVM I/F 240, and an ECC block 250.

In an exemplary embodiment, the control logic 210 controls the operations of the elements 220, 230, 240, and 250 according to the control of the memory controller 140. The UMC memory 220 may be implemented as SRAM. In an exemplary embodiment, the UMC memory 220 stores a mapping table 33 received from the DRAM 30.

In an exemplary embodiment, the DRAM I/F 230 controls the overall data exchange between the control logic 210 and the DRAM 30. In an exemplary embodiment, the DRAM I/F 230 receives the mapping table 33 from the DRAM 30 according to the control of the control logic 210. In an exemplary embodiment, the NVM I/F 240 controls the overall data exchange between the control logic 210 and the storage device 40.

The ECC block 250 generates an ECC during data writing and corrects errors using the ECC during data reading. In an exemplary embodiment, the ECC block 250 includes a DRAM ECC block 251 and an NVM ECC block 253.

In an exemplary embodiment, the DRAM ECC block 251 generates an ECC according to data and stores the ECC in an ECC region 31 in the DRAM 30 when the data is written to the DRAM 30 and may correct errors in the data using the ECC read when the data is read from the DRAM 30. In an exemplary embodiment, the NVM ECC block 253 generates an ECC and stores it in the storage device 40 when data is written to the storage device 40 and may correct errors in the data using the ECC read when the data is read from the storage device 40.

In an exemplary embodiment, the control logic 210 controls the NVM I/F 240 to assign a portion of the storage device 40 as a virtual DRAM region 41. For instance, the control logic 210 may assign the virtual DRAM region 41 for a space corresponding to the ECC region 31 in the DRAM 30. For example, an ECC code associated with data stored in the DRAM 30 that cannot fit in the ECC region 31 could be stored in the virtual DRAM region 41. In another example, data (not an ECC) that is directed to be stored in the DRAM 30, but which cannot fit due to capacity limitations, can be stored in the virtual DRAM region 41. However, the inventive concept is not limited to the currently described exemplary embodiments.

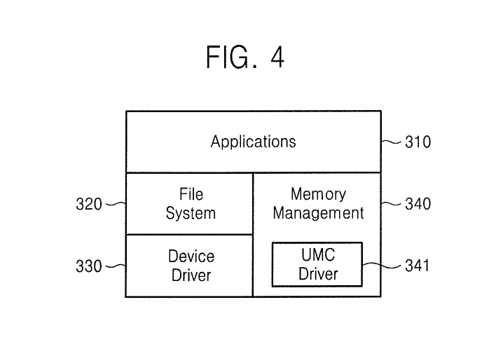

FIG. 4 is a diagram of a software stack in the CPU 120 illustrated in FIG. 1 according to an exemplary embodiment of the inventive concept. Referring to FIGS. 1 and 4, when a controller (not shown) exclusively for the storage device 40 is used instead of using the UMC controller 20, an application 310 sends a read command call for a particular file to a file system 320 and the file system 320 sends a device driver 330 a command to read a particular amount of data from the storage device 40 in response to the read command call. The device driver 330 may control the exclusive controller for the storage device 40 to read data from the storage device 40 in response to the command.

According to the above-described storage path, the CPU 120 accesses the storage device 40 through a long path via the file system 320, i.e., the OS, and therefore, the operating speed is slow.

According to an exemplary embodiment of the inventive concept, a UMC driver 341 of the MMU 150 manages a mapping table. A memory management level 340 of the MMU 150 sends the UMC controller 20 a command to read a particular amount of data from a particular physical address using the UMC driver 311 according to the read command call of the application 310. Accordingly, the application 310 accesses the storage device 40 through a single layer without going through the OS, thereby increasing performance.

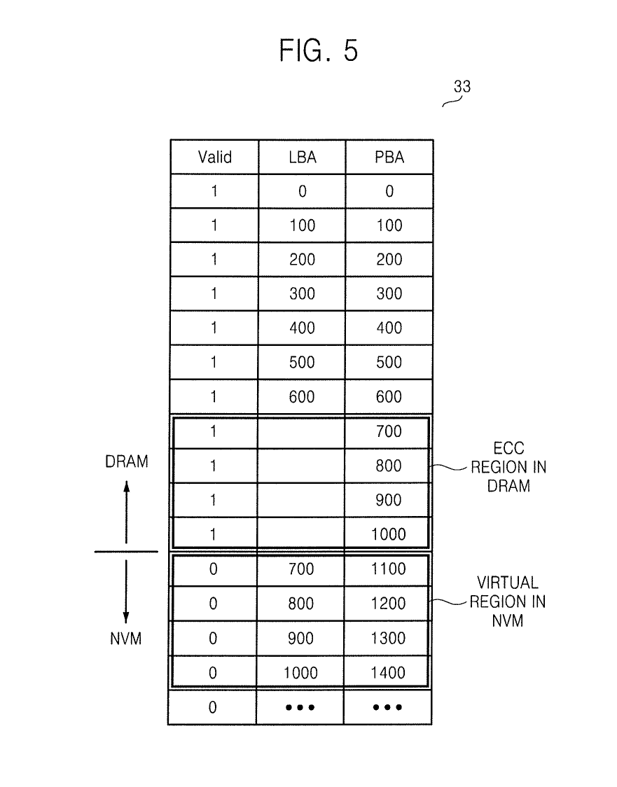

FIG. 5 is a diagram of the mapping table 33 illustrated in FIG. 3 according to an exemplary embodiment of the inventive concept. Referring to FIGS. 1, 3, and 5, the mapping table 33 includes a logical block address (LBA) and a physical block address (PBA). The mapping table 33 maps LBAs (e.g., 0 through 1000) of the MMU 150 to first PBAs (e.g., 0 through 600) corresponding to PBAs of the DRAM 30 and second PBAs (e.g., 1100 through 1400) corresponding to PBAs of the storage device 40.

According to an exemplary embodiment of the inventive concept, the mapping table 33 also includes a valid bit corresponding to each entry. The valid bit indicates whether an LBA or PBA corresponds to the DRAM 30 or the storage device 40. For instance, the UMC controller 20 accesses the DRAM 30 when the valid bit corresponding to the LBA of the host 10 is at a first level (e.g., 1) and accesses the storage device 40 when the valid bit corresponding to the LBA of the host 10 is at a second level (e.g., 0). Alternately, the valid bit can be set to the second level for accessing DRAM 30 and to the first level for accessing the storage device 40.

According to an exemplary embodiment, the first PBAs are different from the second PBAs. For instance, in an exemplary embodiment, the first PBAs have a value equal to or less than a threshold value (e.g., 1000), while the second PBAs have a value exceeding the threshold value (e.g., 1000). The UMC controller 20 may access the DRAM 30 or the storage device 40 according to a first PBA and a second PBA.

When writing data to PBAs of a first range (e.g., 0 through 600) of the DRAM 30, the UMC controller 20 may generate an ECC for the data and store the ECC in PBAs of a second other range (e.g., 700 through 1000) of the ECC region 31.

The UMC controller 20 may assign a portion of the storage device 40 (e.g., a region corresponding to PBAs of 1100 through 1400) as the virtual DRAM region 41. When the DRAM 30 has a capacity of 9 GB and 1 GB is allocated for the ECC region 31, a capacity that can actually be used in the DRAM 30 is reduced to 8 GB. As a result, price competitiveness is decreased.

According to at least one embodiment of the inventive concept, when 9 GB data needs to be stored in the DRAM 30, the UMC controller 20 stores 8 GB data in the DRAM 30 and it sets a portion of the storage device 40 as the virtual DRAM region 41 and stores the remaining 1 GB data in the virtual DRAM region 41. Accordingly, the host 10 may recognize it as the data of 9 GB is stored in the DRAM 30.

When the data is read from the DRAM 30, a page fault may occur at a probability of 1/9, but since most of data is stored in the DRAM 30, the performance is not decreased much. Accordingly, even when an ECC is additionally stored in the DRAM 30, a user can use all of user space in the DRAM 30 without having significant performance deterioration.

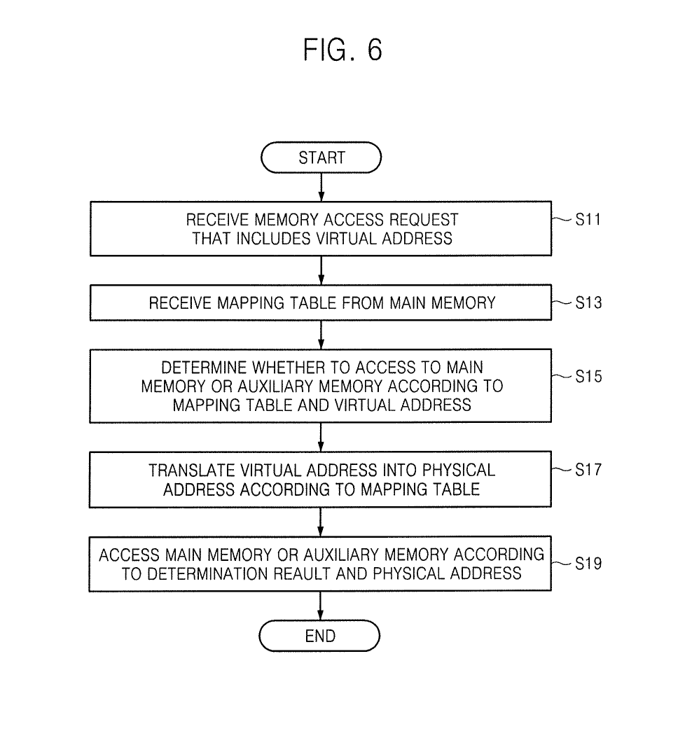

FIG. 6 is a flowchart of a method of operating the electronic system 1 illustrated in FIG. 1 according to an exemplary embodiment of the inventive concept. Referring to FIGS. 1 and 6, the MMU 150 receives a memory access request that includes a virtual address in operation S11. The MMU 150 may receive the memory access request from a host.

The MMU 150 receives a mapping table from the main memory 30 in operation S13. The MMU 150 determines whether to access the main memory 30 or an auxiliary memory (e.g., the storage device 40) according to the mapping table and the virtual address in operation S15. This determination may also include use of the TLB 151.

The MMU 150 may convert the virtual address into a physical address according to the mapping table in operation S17. The MMU 150 may control the UMC controller 20 to access the main memory 30 or the storage device 40 according to the determination result and the physical address in operation S19.

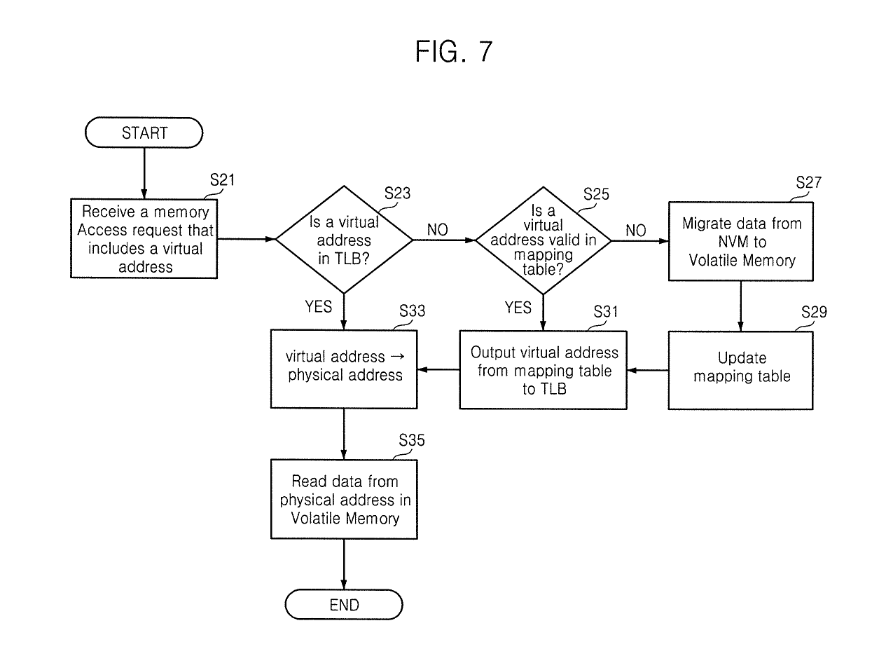

FIG. 7 is a flowchart of a method of operating the electronic system 1 illustrated in FIG. 1 according to an exemplary embodiment of the inventive concept. Referring to FIGS. 1, 3, and 7, the MMU 150 receives a memory access request that includes a virtual address from the CPU 120 in operation S21.

The MMU 150 determines whether the virtual address is in the TLB 151 in operation S23. When the virtual address is not in the TLB 151, the MMU 150 determines whether the virtual address is valid in the mapping table, that is, whether a valid bit corresponding to the virtual address is at the first level in operation S25.

When the virtual address is not valid, a page fault occurs. Accordingly, the UMC controller 20 migrates data from the virtual DRAM region 41 of the storage device (e.g., flash memory) 40 to the main memory 30 in operation S27. In an exemplary embodiment of the inventive concept, a page fault handler of the OS executed by the CPU 120 controls the UMC controller 20 to migrate the data from the virtual DRAM region 41 of the storage device (e.g., flash memory) 40 to the main memory 30 in operation S27. Since the data that is to be migrated may be large, various techniques can be used to select the order in which the data is to be migrated. In a first in, first out (FIFO) technique, the oldest data of the data to be migrated is migrated first. In a most frequently used (MFU) technique, the most frequently used data to be migrated is migrated first. In a most recently used (MRU) technique, the most recently used data to be migrated is migrated first.

When the virtual DRAM region 41 becomes full, it may be necessary to overwrite existing data stored therein. In a first in, first out (FIFO) technique, the oldest data is overwritten first. In a least frequently used (LFU) technique, the least frequently used data is overwritten first. In a least recently used (LRU) technique, the least recently used data is overwritten first.

The MMU 150 updates the mapping table according to the migration of the data in operation S29. When the MMU 150 updates the mapping table or the virtual address is valid, the MMU 150 outputs the virtual address from the mapping table to the TLB 151 in operation S31.

When the MMU 150 outputs the virtual address from the mapping table to the TLB 151 or the virtual address is in the TLB 151, the MMU 150 translates the virtual address into a physical address using the TLB 151 in operation S33. The MMU 150 controls the UMC controller 20 to read data from the physical address in the main memory (e.g., a volatile memory such as the DRAM 30) in operation S35.

The UMC controller 20 may receive at least one first signal C1 corresponding to the interface of the DRAM 30 from the host (e.g., SoC) 10. When the MMU 150 determines it is to access the main memory 30, the UMC controller 20 outputs the first signal C1 to the main memory 30. When the MMU 150 determines it is to access the auxiliary memory (e.g., the storage device 40), the NVM I/F 240 in the UMC controller 20 converts the first signal C1 into at least one second signal C2 corresponding to the interface of the storage device (e.g., flash memory) 40. The UMC controller 20 may output the second signal C2 to the storage device 40.

As described above, according to an exemplary embodiment of the inventive concept, a memory controller for volatile memory and a storage controller for NVM are integrated into one controller, so that cost is reduced as compared to a case where a separate storage controller is used. In addition, the volatile memory can also use an ECC and a space used by the ECC can be compensated for using the NVM.

At least one embodiment of the inventive concept can be embodied as computer-readable codes having computer executable instructions on a computer-readable medium. For example, the operations of FIG. 6 or FIG. 7 may be embodied as computer executable instructions. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices.

While the inventive concept has been particularly shown and described with reference to exemplary embodiments thereof, it will be understood by those of ordinary skill in the art that various changes in forms and details may be made therein without departing from the spirit and scope of the inventive concept.

1. An electronic system comprising:
a host;
a volatile memory;
a non-volatile memory; and
a controller configured to manage the volatile memory and the non-volatile memory according to control of the host,
wherein the controller assigns a portion of the non-volatile memory as a virtual volatile memory region.

2. The electronic system of claim 1, wherein the volatile memory comprises a mapping table that maps a logical address of the host to a first physical address of the volatile memory and a second physical address of the non-volatile memory.

3. The electronic system of claim 2, wherein the mapping table comprises a valid bit corresponding to each entry; and
the controller receives the mapping table from the volatile memory, accesses the volatile memory when the valid bit corresponding to the logical address of the host is at a first level, and accesses the non-volatile memory when the valid bit corresponding to the logical address of the host is at a second level.

4. The electronic system of claim 2, wherein the first physical address is different from the second physical address.

5. The electronic system of claim 1, wherein the volatile memory stores volatile data and an error correction code (ECC) corresponding to the volatile data.

6. The electronic system of claim 5, wherein the controller assigns a space corresponding to the ECC in the non-volatile memory as the virtual volatile memory region.

7. The electronic system of claim 1, wherein the controller receives at least one first signal corresponding to an interface of the volatile memory from the host and accesses the volatile memory or the non-volatile memory according to the first signal.

8. The electronic system of claim 7, wherein the controller comprises a non-volatile memory interface configured to convert the first signal into at least one second signal corresponding to an interface of the non-volatile memory.

9. The electronic system of claim 8, wherein the controller outputs the first signal to the volatile memory or outputs the second signal to the non-volatile memory.

10. The electronic system of claim 1, wherein the host and the controller are integrated into a single system-on-chip.

11-15. (canceled)

16. An electronic system comprising:
a volatile memory;
a non-volatile memory; and
a controller configured to interface with both the volatile memory and the non-volatile memory,
wherein the controller is configured to receive a request to store data into the volatile memory, and
wherein the controller stores a part of the data that exceeds a capacity of the volatile memory into the non-volatile memory.

17. The electronic system of claim 16, further comprising:
a memory controller configured to generate a first signal configured to interface with the volatile memory,
wherein the controller sends the first signal received from the memory controller to the volatile memory to store the data not exceeding the capacity into the volatile memory.

18. The electronic system of claim 17, wherein the controller converts the first signal into a second signal configured to interface with the non-volatile memory, and sends the second signal to the non-volatile memory to store the data exceeding the capacity into the non-volatile memory.

19. The electronic system of claim 16, wherein the non-volatile memory comprises a first region for storing the part of the data, and a second other region for storing data that is requested to be stored into the non-volatile memory.

20. The electronic system of claim 16, wherein the controller accesses a mapping table of the volatile memory to determine whether data of the non-volatile memory requested by a host is located in one of the volatile memory and the non-volatile memory.
